(19) United States
(12) Patent Application Publication
(10) Pub. No.: US 2005/0165884 A1
(43) Pub. Date: Jul. 28, 2005

(54) System and method for automated distributed account maintenance

(76) Inventor: William J. Masek, Bedford, MA (US)

Correspondence Address: PILLSBURY WINTHROP SHAW PITTMAN, LLP, P.O. BOX 10500, MCLEAN, VA, 22102, US

(21) Appl. No.: 10/745,536

(22) Filed: Dec. 29, 2003

(51) Int. Cl. G06F 15/16

(52) U.S. Cl. 709/201

(57) ABSTRACT

A system and method is provided for maintaining and synchronizing multiple accounts in a distributed environment. Updates to accounts at one location are automatically propagated to other locations within the distributed environment. A user of a local system who is disconnected at the time of the update may later receive the update when connecting to any system within the distributed environment.

### FIELD OF THE INVENTION

This invention relates to a system and method for maintaining and synchronizing multiple accounts in a distributed environment.

### BACKGROUND OF THE INVENTION

Having several computer user accounts is generally known. In a distributed computing environment, a user may have accounts on several machines. It is difficult for a user to keep accounts synchronized since the user may not always be connected to the computer systems. Still, users want notifications when new features are available.

A user typically has access to many software applications having many features that the user may or may not want or need to access. A user or system administrator may enable and disable the desired features and this information may be stored as account data. However, updates at one account location may not be reflected at other account locations, and a user or system administrator would have to enable and/or disable features at each account location. This can be very inefficient.

In conventional systems, most accounts are centralized. In other words, a central location that stores all, or at least a majority of the account data. Centralization allows changes to occur in one location. However, centralization creates problems for a user who is disconnected from the network. This user may be unable to effectively use his account data because the system does not know which features to offer the user.

Some systems have attempted to solve these and other problems by allowing account data to be copied to multiple systems. However, problems still exist with synchronizing account data across different systems. Updates at one location may not be automatically propagated to other locations, and data may need to be stored differently on different systems.

Other problems and limitations also exist.

### SUMMARY OF THE INVENTION

The invention overcoming these and other problems and limitations with conventional systems relates to a system and method for automated distributed account maintenance. Replication and software agents may be used to automate the maintenance process. In one embodiment, the invention uses replication to synchronize data across multiple systems, solving problems where systems are not always connected.

According to one embodiment of the invention, the system may include a local device having local account information and multiple remote servers. A system administrator may update user accounts at a server and the server may replicate the update to other servers and local accounts.

According to further embodiments, an update to a local account may update account information for a single user.

A user may wish to maintain a local account for both online and offline use. However, the user may have missed one or more account updates while working offline. According to one embodiment of the invention, a local account user may receive missed updates when connecting to any of the one or more servers within the distributed environment.

A user having access to multiple software applications having multiple features may only want and/or need to use some of the available applications and/or features. According to one embodiment of the invention, a user account stores information related to the enabled and/or disabled applications and/or features. Changes to the account information at one locations may be replicated at other account locations.

According to another embodiment of the invention, account updates may be customized and/or formatted for compatibility with each server and/or local terminal device.

A user may want to know when an update to their system has occurred. According to one embodiment of the invention, an update agent may be used to notify the user of a new account update.

Other objects and features of the invention will become apparent from the following detailed description considered in connection with the accompanying drawings that disclose embodiments of the invention. It should be understood, however, that the drawings are designed for purposes of illustration only and not as a definition of the limits of the invention.

### BRIEF DESCRIPTION OF THE DRAWINGS

FIG. 1 illustrates an overall system for distributed account maintenance according to an embodiment of the invention.

FIG. 2 illustrates a process for synchronizing multiple accounts according to an embodiment of the invention.

FIG. 3 illustrates a method for receiving updated account information according to an embodiment of the invention.

### DETAILED DESCRIPTION OF THE INVENTION

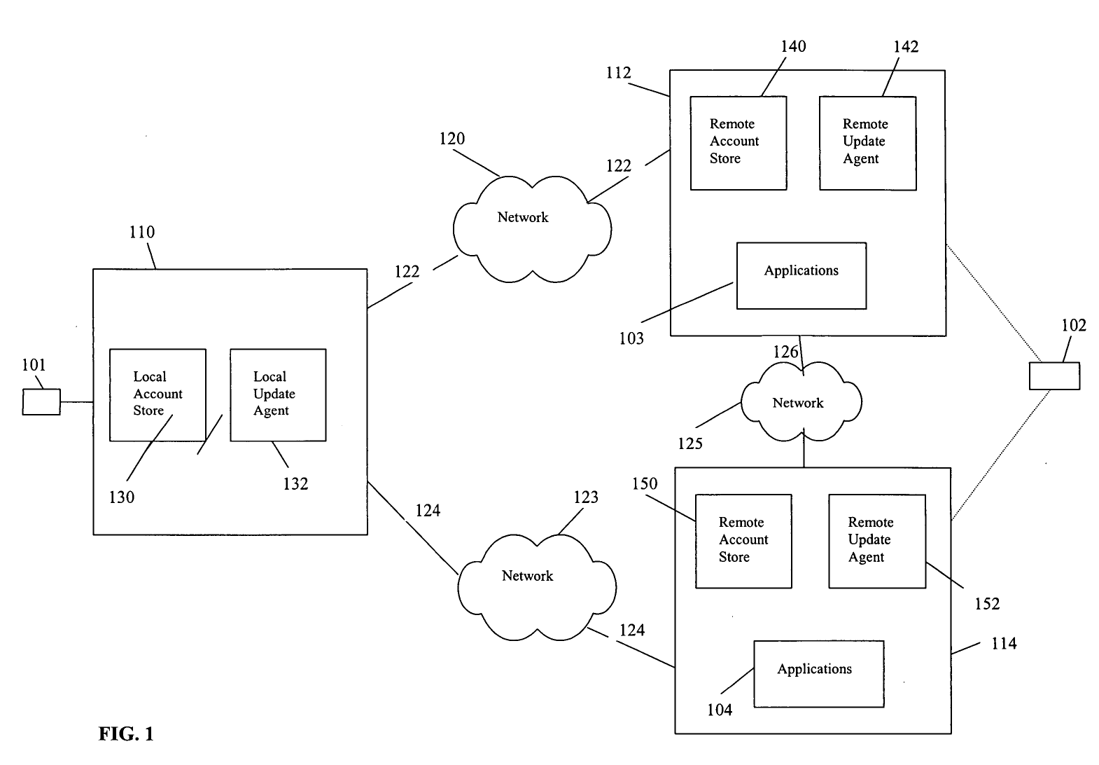

According to an aspect of the invention as illustrated in FIG. 1, a system 100 is provided to enable a user 101 to maintain and synchronize multiple accounts in a distributed, off-line environment. Specifically, system 100 enables a user having one or more computer accounts to utilize account stores and update agents to receive account updates at multiple locations. A user account may include, for example, user password information, user identification, user permissions to access certain software applications, and other user account information. A user account may also be used to enable and/or disable features of a particular software application. For example, a software application, such as, for example, Microsoft Outlook may be configured to include a preview of each message. Other user configurations and software applications are applicable.

As illustrated in FIG. 1, system 100 may include a terminal device 110. Terminal device 110 may be connected to multiple remote servers such as, for example, a first remote server 112 and a second remote server 114. Connection between terminal device 110 and remote server 112 may be over network 120, via communication link 122. Connection between terminal device 110 and remote server 114 may be over network 123, via communication link 124. Examples of terminal device 110 may include any one or more of, for example, a desktop computer, a laptop or other portable computer, a hand-held computer device such as a Blackberry, a Personal Digital Assistant (PDA), a web-enabled mobile phone, or a Palm Pilot, or any other terminal device.

Remote servers 112, 114 may be or include, for example, a workstation running Microsoft Windows™ NT™, Microsoft Windows™ 2000, Unix, Linux, Xenix, IBM, AIX™, Hewlett-Packard UX™, Novell Netware™, Sun Microsystems Solaris™, OS/2™, BeOS™, Mach, Apache, OpenStep™, or other operating system.

Network 120, 123 may include any one or more networks. For instance, network 120 may include the Internet, an intranet, a PAN (Personal Area Network), a LAN (Local Area Network), a WAN (Wide Area Network), a SAN (Storage Area Network), a MAN (Metropolitan Area Network), or other network.

Communications links 122, 124 may include any one or more communications links. For instance, communications links 122, 124 may include a copper telephone line, a Digital Subscriber Line (DSL) connection, a Digital Data Service (DDS) connection, an Ethernet connection, an Integrated Services Digital Network (ISDN) line, an analog modem connection, a cable modem connection, a wireless connection, or other communications link.

Terminal device 110 may be used when connected to a remote server or may be used off-line. Terminal device 110 may include a local account store 130 and a local update agent 132. Local account store 130 may store information related to a single user account if being used by only a single user or multiple user accounts if being used by multiple users. Information stored in local account store 130 may include, for example, a user profile, one or more user applications, and/or other user specific information. Local update agent 132 may receive account updates from multiple remote server locations, such as remote servers 112, 114. Local update agent 132 may also customize data as needed for the particular system being used at terminal device 110 and may also provide notifications to a user of terminal device 110 when updates occur.

Remote servers 112, 114 may each include one or more remote account stores, such as, for example, a remote account store 140 and a remote account store 150. Remotes servers 112, 114 may also include one or more software applications 103, 104, having various features, to be used by one or more users. Remote servers 112, 114 may also include one or more remote update agents, such as, for example remote update agent 142 and remote update agent 152. Remote account stores 140, 150 maintain account information for each of the multiple users accessing remote servers 112,114.

Account information may include, for example, user password information, user identification, permission to access certain software applications, and other user account information. Account information may also include configurations to enable or disable certain features of software applications 103, 104 view within software applications 103, 104 or other settings. Remote update agents 142, 152 may receive updates from a system administrator 102.

Remote update agents 142, 152 may also receive and generate updates between each other over network 125 via communications link 126. Remote update agents 142, 152 may also be used to format and customize data in a format compatible with the system in use.

System administrator 102 may define parameters for user accounts for multiple users at remote servers 112, 114. System administrator 102 may define parameters such as, for example, user identification, user password, and other user parameters. System administrator 102 may also define which applications should be delivered to a user. System administrator 102 may also enable and/or disable features related to an application for a particular user account. Other tasks may also be performed by system administrator 102.

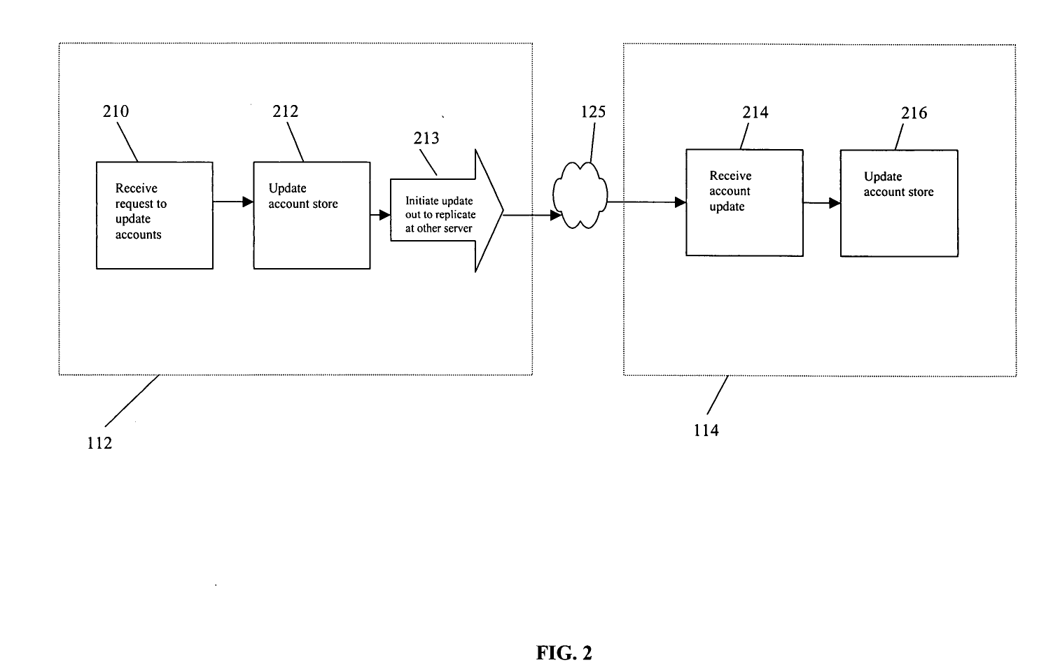

FIG. 2 illustrates an overall process for synchronizing remote servers 112, 114. In an operation 210, remote server 112 receives a request to update remote account store 140 from system administrator 102. In an operation 212, the account store at remote server 112 is updated. Updates to the account store may include, for example, resetting a user password, adding new user identification, adding and/or changing software applications that a user has access to, enabling and/or disabling features of an application, enabling and/or disabling certain views of an application, and/or other updates. In an operation 213, an update out action is initiated to replicate remote server 112 at remote server 114. The update out action traverses network 125. Remote server 114 receives the update information, as shown at 214, and updates its account store with the new information, as shown at 216.

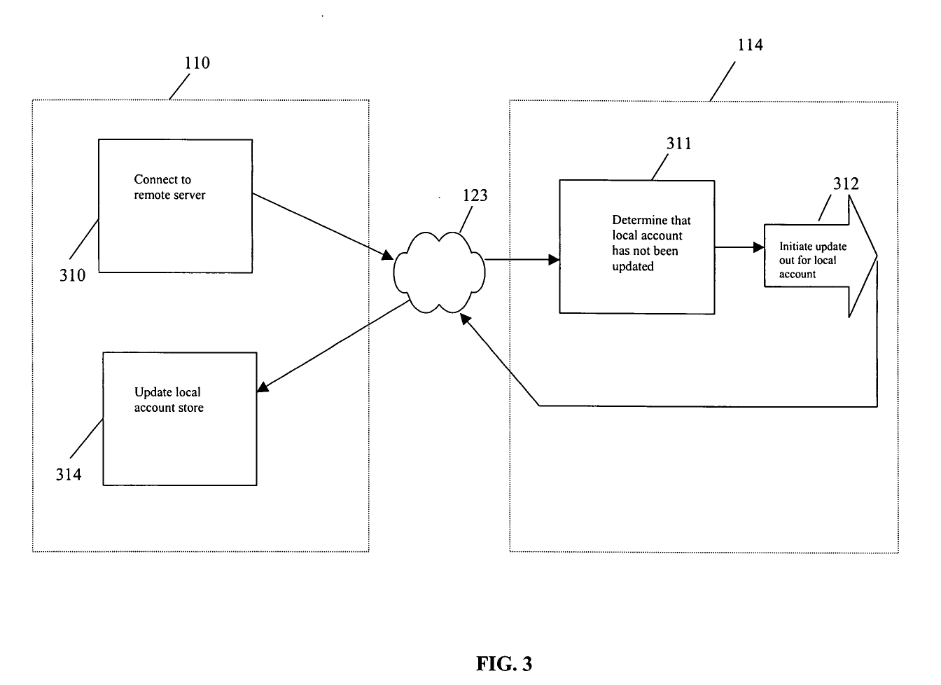

A user may want to maintain a local account for both online and offline use. While offline, a local user may have missed an update. FIG. 3 illustrates a process for receiving a missed update by a local user. In an operation 310, a user at terminal device 110 connects to remote server 114. Remote server 114 determines that the local account has not been updated, in an operation 311. Remote server 114 then sends recently received updates to local terminal device 110, in an operation 312. Local update agent 132 may then update account information for the user, in an operation 314. Because terminal device 110 is typically used by a single user, only that user's data is updated locally.

While not illustrated, a user may later connect to remote server 112. The replication process at remote server 112 recognizes that the local account as already been updated and makes no additional changes, unless, of course, changes have occurred in the interim. The accounts were updated only once, despite the potential for multiple updates.

With automated updates, some users may wish to know when an update to their system has occurred. According to one embodiment, local update agent 132 may inform a user of a new account update. When a user connects to a server, such as remote server 112, 114, notification may occur by presenting a pop-up message window to the user after the update is complete, sending an email reporting the update, or other known methods of notification.

In some embodiments, account data should not be blindly copied. Data may need to be stored differently on different systems. While not illustrated in FIG. 2 or FIG. 3, update agents may customize data for compatibly with the system in use. There are many reasons why data may have to be formatted differently for use at different systems. For example, terminal device 110 and remote servers 112 and 114 may consist of different platforms and may run on different operating systems.

Furthermore, while remote servers 112 and 114 typically support one or more users, terminal device 110 is typically used to support a single user. Since remote servers 112 and 114 may support more than one user, these servers may be expanded with additional memory resources. Terminal device 110 may be constrained by size, weight, power restrictions, or other constraints, and may not be able to add additional memory resource. Also, data related to variations across different users at servers 112 and 114 do not need to be stored at terminal device 110 if it is not related to user 101. In this case, the data may be summarized at terminal device 110. To compensate for the differences in resources and needs, data may have to be formatted differently for terminal device 110 than for servers 112 and 114.

Additionally, data may need to be stored differently at terminal device 110 to support off-line, disconnected operation. For example, terminal device 110 may buffer data that remote servers 112 and 114 may process immediately. The buffers created at terminal device 110 may not be needed at remote servers 112 and 114. Update agents 132,142, 152 may be used to format the received update in a manner compatible with each device.

While particular embodiments of the present invention have been described, it is to be understood that modifications will be apparent to those skilled in the art without departing from the spirit of the invention. The scope of the invention is not limited to the specific embodiments described herein. Other embodiments, uses and advantages of the invention will be apparent to those skilled in the art from consideration of the specification and practice of the invention disclosed herein. The specification should be considered exemplary only, and the scope of the invention is accordingly to be limited by the following claims.

1. A method for maintaining and synchronizing multiple accounts in a distributed, off-line environment, the method comprising:
receiving, at a first account location, account update information for updating account data from a system administrator wherein the account data includes applications and features, which may be enabled or disabled;
replicating the update information for sharing with a plurality of other account locations; and
sending the updated information to the plurality of other account locations within the distributed environment wherein the enabled and disabled features are retained without having to configure the applications and features at each account location.

2. The method of claim 1 wherein the replicating step further comprises:
generating an update out action to replicate the plurality of other account locations within the distributed environment.

3. A method for synchronizing a local account with a plurality of accounts in a distributed, off-line environment, the method comprising:
connecting to one of a plurality of remote account locations;
receiving updated information for account data from the remote account location wherein the remote location has previously received updated information while the local account was disconnected and wherein the account data includes applications and feature, which may be enabled or disabled, for which one or more users have access to; and
updating the local account with the updated information wherein the local account only receives updated information for a user of the local account and wherein the enabled and disabled features are retained without having to configure the applications and features at the local account.

4. The method of claim 3 further comprising receiving updated information further comprises:
receiving updated account information at the local user account when a user connects to any of a plurality of systems within the distributed environment.

5. The method of claim 3 further comprising:
storing the updated account information in a format compatible with the local account location; and
notifying the user of the local account that the local account has been updated.

6. A system for maintaining and synchronizing multiple accounts in a distributed, off-line environment, the system comprising:
at least one terminal device for accessing at least one local account; and
a plurality of account locations storing account data for a plurality of users wherein each of the plurality of account locations further comprises:
an account store for storing account information for a plurality of users; and
an update agent for sending and receiving account information updates.

7. The system of claim 6 wherein said account data includes applications and features, which may be enabled or disabled, that one or more users have access to and wherein when said update agent sends and receives the account information updates, the enabled and disabled features are retained without having to configure each of the one or more account locations.

8. The system of claim 6 wherein the update agent further comprises:
a formatting agent for storing account information in a format compatible with the account location; and
a notification agent for notifying a user of account updates.

9. The system of claim 6 wherein said at least one local account may be for online and offline use and wherein said at least one local account further comprises:
a local account store for storing account information for a single user; and
a local update agent for receiving account information updates and notifying a local user of account updates.

10. The system of claim 9 wherein the local update agent may receive an account update when connecting to any of a plurality of systems within the distributed environment.

11. The system of claim 9 wherein the local update agent further comprises:
a formatting agent for storing account information in a format compatible with the account location.
